(19) United States
(12) Patent Application Publication
(10) Pub. No.: US 2025/0175070 A1
(43) Pub. Date: May 29, 2025

(54) POWER SUPPLY CIRCUIT AND CONTROL METHOD

(71) Applicant: Delta Electronics (Shanghai) CO., LTD., Shanghai (CN)

(72) Inventors: Yexuan ZHENG, Shanghai (CN); Yuhua HU, Shanghai (CN); Youzhun CAI, Shanghai (CN); Yuxi QIAO, Shanghai (CN)

(73) Assignee: Delta Electronics (Shanghai) CO., LTD., Shanghai (CN)

(21) Appl. No.: 18/956,081

(22) Filed: Nov. 22, 2024

(30) Foreign Application Priority Data
Nov. 28, 2023 (CN) 2023116092977

(51) Int. Cl. H02M 1/00; H02M 1/34; H02M 1/42; H02M 7/06; H02M 7/08

(52) U.S. Cl. CPC H02M 1/0025; H02M 1/0009; H02M 1/348; H02M 1/4208; H02M 7/066; H02M 7/08

(57) ABSTRACT

Disclosed is a power supply circuit, including: a voltage source, providing an input voltage; a switch unit, a first terminal thereof being electrically coupled to a first terminal of the voltage source; a first capacitor, having an initial voltage, a first terminal thereof being electrically coupled to a second terminal of the switch unit, and a second terminal thereof being electrically coupled to a second terminal of the voltage source; a reference signal generating unit, configured to generate a first reference signal according to a first time, and a difference between a peak value of the input voltage and the initial voltage of the first capacitor; and a control unit, configured to obtain a real-time voltage of the first capacitor, and generate a first control signal for controlling the switch unit according to the first reference signal and the real-time voltage of the first capacitor.

### CROSS REFERENCE

This application is based upon and claims priority to Chinese Patent Application No. 2023116092977, filed on Nov. 28, 2023, the entire contents thereof are incorporated herein by reference.

### TECHNICAL FIELD

The present disclosure relates to the technical field of power supply, and particularly, to a power supply circuit and a control method.

### BACKGROUND

For a power supply with an auto transfer switch (ATS) function, if the input power supply is switched or the power supply is in a soft start state, a surge current may be generated in the circuit. In the related art, in order to limit the damage caused by excessive surge current, a current limiting resistor is connected in series in the circuit to limit the surge current. However, due to the resistance characteristics of the current limiting resistor, the current limiting resistor may generate a huge voltage during a lightning surge, which may result in damage to the components in the power supply. In addition, the transient power of the current limiting resistor is large, and thus a sufficiently large volume is required to dissipate heat, which will result in large volume of the power supply and low power density of the power supply.

It should be noted that the information disclosed in the above BACKGROUND section is only used to enhance an understanding of the background of the present disclosure, therefore it may include information that does not constitute the prior art known to those skilled in the art.

### SUMMARY

The present disclosure provides a power supply circuit and a control method, which at least to a certain extent overcome the problems of damages to the component caused by surge current, and the large volume and low power density of the power supply with an ATS function in the related art.

Other features and advantages of the present disclosure will become apparent through the following detailed description, or, may be learned partially by practice of the present disclosure.

According to an aspect of the present disclosure, a power supply circuit is provided, where the power supply circuit includes:
a voltage source, providing an input voltage and, including a first terminal and a second terminal;
a switch unit, including a first terminal and a second terminal, where the first terminal of the switch unit is electrically coupled to the first terminal of the voltage source;
a first capacitor, having an initial voltage, where the first capacitor includes a first terminal and a second terminal, the first terminal of the first capacitor is electrically coupled to the second terminal of the switch unit, and the second terminal of the first capacitor is electrically coupled to the second terminal of the voltage source;
a reference signal generating unit, configured to generate a first reference signal according to a first time, a difference between a peak value of the input voltage and the initial voltage of the first capacitor; and
a control unit, configured to obtain a real-time voltage of the first capacitor, and generate a first control signal according to the first reference signal and the real-time voltage of the first capacitor, where the first control signal is used to control the switch unit.

According to a second aspect of the present disclosure, a control method for the power supply circuit is further provided, where the method includes:
the reference signal generating unit calculating the difference between the peak value of the input voltage and the initial voltage of the first capacitor, and generating the first reference signal according to the difference and the first time; where the reference signal represents a voltage change over time;
cyclically performing following steps until an adjustment time is greater than or equal to the first time, and sending, by the control unit, the first control signal to the switch unit, where the first control signal is a keep turning-on instruction:
obtaining, by the control unit, a real-time voltage of the first capacitor at a current moment;
determining, by the control unit, a duration from an initial moment to the current moment to obtain the adjustment time;
sending, by the control unit, the first control signal to the switch unit in response to that the control unit determines that the real-time voltage of the first capacitor at the current moment is greater than a value of the first reference signal at the current moment, where the first control signal is a turning-off instruction;
sending, by the control unit, the first control signal to the switch unit in response to that the control unit determines that the real-time voltage of the first capacitor at the current moment is less than or equal to the value of the first reference signal at the current moment, where the first control signal is a turning-on instruction; and
determining, by the control unit, whether the adjustment time is greater than or equal to the first time, and re-obtaining, by the control unit, the real-time voltage of the first capacitor in response to determining that the adjustment time is less than the first time.

According to a third aspect of the present disclosure, an electronic device is further provided, where the electronic device includes: a processor; and a memory configured to store executable instructions of the processor; where the processor is configured to execute the control method for the power supply circuit as described in any one of the first aspect above by executing the executable instructions.

According to a fourth aspect of the present disclosure, a computer-readable storage medium is further provided, on which a computer program is stored. When the computer program is executed by a processor, the control method for the power supply circuit as described in any one of the first aspect above is implemented.

According to a fifth aspect of the present disclosure, a computer program product is further provided, where the computer program product includes a computer program, when the computer program is executed by a processor, the control method for the power supply circuit as described in any one of the first aspect above is implemented.

The power supply circuit provided in the embodiments of the present disclosure achieves the current limiting function by providing a switch unit, a control unit, and a reference signal generating unit, where the control unit controls the on and off of the switch unit to enable the real-time voltage of the first capacitor to be adjusted in accordance with the form of the set first reference signal. Further, compared with current limiting resistors, the switch unit will not generate a huge voltage during lightning surges, thus avoiding damage to components; the instantaneous power of the switch unit will not be very large, thereby eliminating the need for a large volume for heat dissipation, and enabling the volume of the power supply with the ATS function to be reduced, thus increasing the power density.

It should be understood that the foregoing general description and the following detailed description are exemplary and explanatory only, and do not limit the present disclosure.

### BRIEF DESCRIPTION OF THE DRAWINGS

The accompanying drawings herein, which are incorporated in and constitute a part of this specification, illustrate embodiments consistent with the present disclosure and are used in conjunction with the specification to explain the principles of the present disclosure. Obviously, the drawings in the following description are only some embodiments of the present disclosure. For those of ordinary skill in the art, other drawings can also be obtained from these drawings without paying creative effort.

FIG. 1 shows a schematic diagram of a power supply circuit in an embodiment of the present disclosure;

FIG. 2 shows a schematic diagram of a power supply circuit in some embodiments of the present disclosure;

FIG. 3 shows a schematic diagram of another power supply circuit in some embodiments of the present disclosure;

FIG. 4 shows a schematic diagram of yet another power supply circuit in some embodiments of the present disclosure;

FIG. 5 shows a schematic diagram of still another power supply circuit in some embodiments of the present disclosure;

FIG. 6 shows a schematic diagram of a control method applied to the power supply circuit shown in FIG. 1 according to an embodiment of the present disclosure;

FIG. 7 shows a schematic diagram of a waveform of a first reference signal in an embodiment of the present disclosure;

FIG. 8 shows a schematic diagram of a waveform of another first reference signal in an embodiment of the present disclosure;

FIG. 9 shows a schematic diagram of a waveform of still another first reference signal in an embodiment of the present disclosure;

FIG. 10 shows a schematic diagram of a control method for the power supply circuit in some embodiments of the present disclosure;

FIG. 11 shows a schematic diagram of constructional connections of the power supply circuit in some embodiments of the present disclosure;

FIG. 12 shows a schematic diagram of a specific implementation process of the control method for the power supply circuit shown in FIG. 10;

FIG. 13 shows a schematic diagram of a control method applied to the power supply circuit shown in FIG. 3 in some embodiments of the present disclosure;

FIG. 14 shows a schematic diagram of a control method applied to the power supply circuit shown in FIG. 4 in some embodiments of the present disclosure;

FIG. 15 illustrates a schematic diagram of another control method for the power supply circuit in some embodiments of the present disclosure;

FIG. 16 shows a schematic diagram of a control method applied to the power supply circuit shown in FIG. 5 in some embodiments of the present disclosure;

FIG. 17 shows a schematic diagram of level variations of the driving signals of various components when S1606 is specifically implemented in some embodiments of the present disclosure;

FIG. 18 shows a schematic diagram of a power supply circuit of a specific example of the present disclosure; and

FIG. 19 shows a waveform diagram of an input voltage and a waveform diagram of a voltage of the first capacitor of the power supply circuit in a specific example of the present disclosure.

### DETAILED DESCRIPTION

Exemplary implementations will now be described more fully with reference to the accompanying drawings. Exemplary implementations may, however, be embodied in various forms and should not be construed as limited to the examples set forth herein. Rather, these implementations are provided so that the present disclosure will be more thorough and complete, and the concepts of the exemplary implementations will be fully conveyed to those skilled in the art. The described features, structures, or characteristics may be combined in one or more implementations in any suitable manner.

In addition, the accompanying drawings are only schematic illustrations of the present disclosure and are not necessarily drawn to scale. In the drawings, the same reference sign indicates the same or similar part, and repeated descriptions thereof will be omitted. Some of the block diagrams shown in the accompanying drawings are functional entities and do not necessarily correspond to physically or logically independent entities. These functional entities may be implemented in software form, or in one or more hardware modules or integrated circuits, or in different networks and/or processor apparatuses and/or microcontroller apparatuses.

Specific implementations of the embodiments of the present disclosure are described in detail below in conjunction with the accompanying drawings.

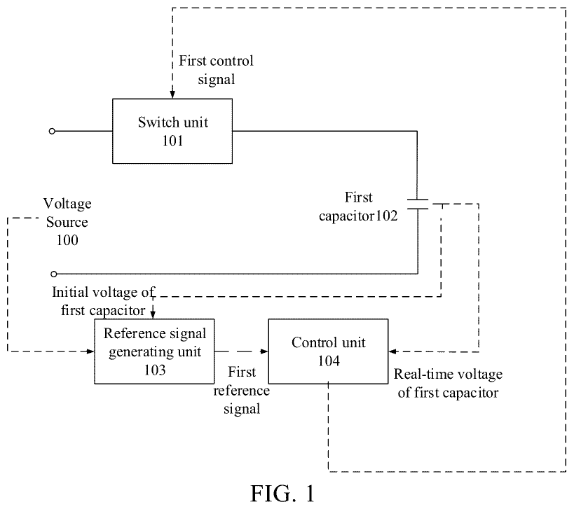

As shown in FIG. 1, a power supply circuit provided in an embodiment of the present disclosure includes:
a voltage source 100, providing an input voltage and including a first terminal and a second terminal;
a switch unit 101, including a first terminal and a second terminal, where the first terminal of the switch unit 101 is electrically coupled to the first terminal of the voltage source 100;
a first capacitor 102 having an initial voltage, where the first capacitor 102 includes a first terminal and a second terminal, the first terminal of the first capacitor 102 is electrically coupled to the second terminal of the switch unit 101, and the second terminal of the first capacitor 102 is electrically coupled to the second terminal of the voltage source 100;
a reference signal generating unit 103, configured to generate a first reference signal according to a first time, a difference between a peak value of the input voltage of the voltage source 100 and the initial voltage of the first capacitor 102; it should be noted that the first time is a total duration of a preset anti-surge startup phase, and the first reference signal is a curve of voltage variation over time, that is, the voltage of the first capacitor 102 needs to grow from the initial voltage to the peak value of the input voltage within the duration of the first time;
a control unit 104, configured to obtain a real-time voltage of the first capacitor 102, and generate a first control signal according to the first reference signal and the real-time voltage of the first capacitor 102, where the first control signal is used to control the switch unit 101.

It should be noted that the reference signal generating unit 103 and the control unit 104 may be independently provided, or integrated in the same device to save costs and reduce the occupied volume, which is conducive to integration and further reducing the volume of the ATS power supply. The first control signal may be a pulse width modulation (PWM) control signal to control the state of the switch unit 101 to be on or off.

In the power supply circuit provided in the embodiments of the present disclosure, a switch unit 101, a control unit 104, and a reference signal generating unit 103 are provided, and the control unit 104 controls the on and off of the switch unit 101 to enable the real-time voltage of the first capacitor 102 to be changed in accordance with the waveform of the first reference signal, so that the current limiting function is achieved. Further, compared with the current limiting resistor, the switch unit 101 will not generate a huge voltage during lightning surges, thus avoiding damage to components; the instantaneous power of the switch unit 101 will not be very large, thereby eliminating the need for a large volume for heat dissipation, and enabling the volume of the power supply with the ATS function to be reduced, thus increasing the power density.

It should be noted that the control unit 104 is further configured to: obtain a real-time voltage of the voltage source 100, and generate the first control signal according to the first reference signal, the real-time voltage of the first capacitor 102 and the real-time voltage of the voltage source 100, and the first control signal is used to control the switch unit 101. The control unit 104 is specifically used to determine whether the real-time voltage of the input voltage is an AC input or a DC input. In the case of AC input, it is determined whether the power supply circuit is operating in a buck mode or a boost mode according to the real-time voltage of the voltage source 100 and the real-time voltage of the first capacitor 102. In the case of DC input, it is determined that the power supply circuit operates in the buck mode, and the first control signal is generated in conjunction with the first reference signal.

It should be noted that the switch unit 101 may include a switching transistor and a relay connected in parallel. In specific implementation, during the anti-surge startup phase, the relay is not turned on, and the switch unit 101 achieves the function of turning on or off through the switching transistor. After the anti-surge startup phase is over, the switching transistor may be turned off, and the relay is turned on so that the operating current flows through the relay in a stable operating state (no surge current) to reduce the loss of power in the circuit.

In some embodiments of the present disclosure, the first reference signal includes N steps of reference voltages, each step of the reference voltage corresponds to a segment of reference time, and a sum of N segments of reference time corresponding to the N steps of reference voltages is equal to the first time, where N 1.

In some embodiments of the present disclosure, in order to prevent excessive current in the power supply circuit from damaging the circuit, the control unit 104 generates the first control signal according to the first reference signal, the real-time voltage of the first capacitor, and a real-time current of the first terminal of the switch unit 101.

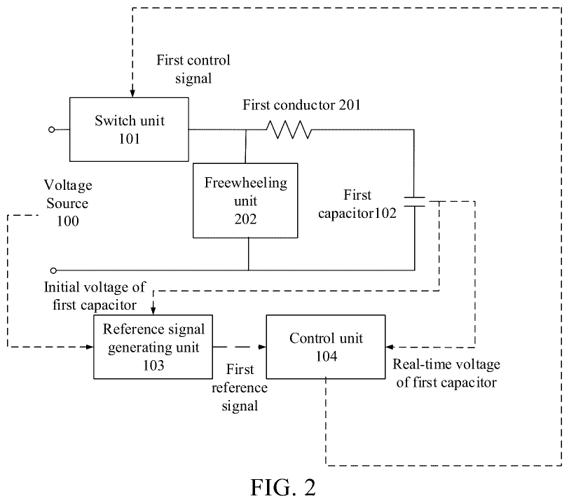

In some embodiments of the present disclosure, when the switch unit 101 is in the off state, in order to maintain the voltage of the first capacitor 102, an inductor and a freewheeling unit may be added for freewheeling. Therefore, the power supply circuit provided is shown in FIG. 2, and on the basis of FIG. 1, the power supply circuit further includes:
a first inductor 201 and a freewheeling unit 202, where a first terminal of the first inductor 201 and a first terminal of the freewheeling unit 202 are both electrically coupled to the second terminal of the switch unit 101, a second terminal of the first inductor 201 is electrically coupled to the first terminal of the first capacitor 102, and a second terminal of the freewheeling unit 202 is electrically coupled to the second terminal of the first capacitor 102. In a specific implementation, the freewheeling unit 202 may be a diode, the cathode of the diode is connected to the second terminal of the switch unit 101, and the anode of the diode is connected to the second terminal of the first capacitor 102.

In some embodiments of the present disclosure, the power supply circuit further includes a voltage conversion unit, where the voltage conversion unit includes the first inductor 201. It should be noted that the voltage conversion unit includes a boost circuit or a power factor correction (PFC) circuit such as a totem-pole power factor correction circuit. In a specific implementation, the voltage conversion unit is connected between the switch unit 101 and the first capacitor 102, and is configured to increase or decrease the voltage input via the switch unit 101 and then transmit the voltage to the first capacitor 102 to charge the first capacitor 102.

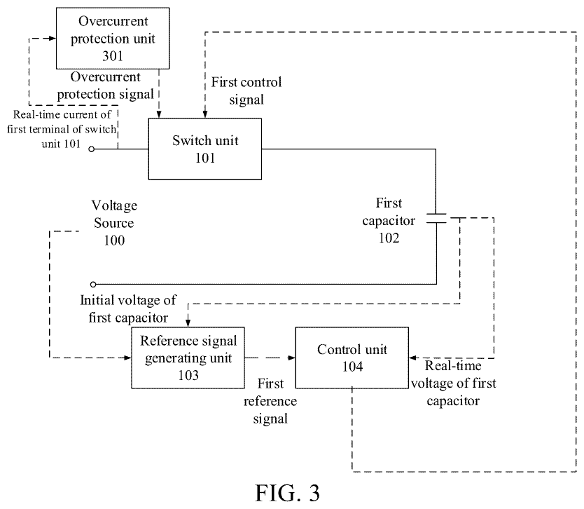

In some embodiments of the present disclosure, in order to prevent excessive current from damaging the circuit, the power supply circuit provided is shown in FIG. 3, and on the basis of FIG. 1, the power supply circuit further includes: an overcurrent protection unit 301, where the overcurrent protection unit 301 generates an overcurrent protection signal according to a current threshold and a real-time current of the first terminal of the switch unit 101 to perform overcurrent protection for the power supply circuit.

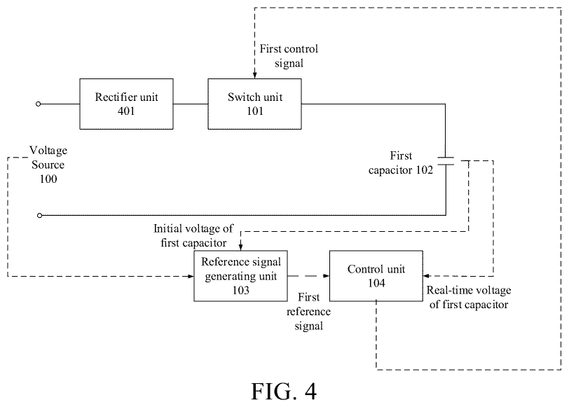

In some embodiments of the present disclosure, when the input voltage is in AC form, the input voltage needs to be rectified. Accordingly, the power supply circuit provided is shown in FIG. 4, and on the basis of FIG. 1, the power supply circuit further includes: a rectifier unit 401, including a first terminal and a second terminal, where the first terminal of the rectifier unit 401 is electrically coupled to the voltage source 100, the second terminal of the rectifier unit 401 is electrically coupled to the switch unit 101, and the rectifier unit 401 is configured to perform AC to DC conversion when the input voltage is in AC form.

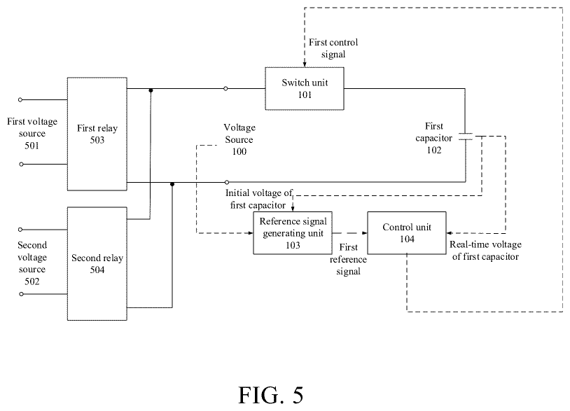

In some embodiments of the present disclosure, the power supply circuit may switch the power supply source in situations such as an unstable operating condition of the currently used power supply source, so as to ensure the stability of the power supply source. Accordingly, as shown in FIG. 5, the voltage source includes: a first voltage source 501 and a second voltage source 502, the first voltage source 501 is connected to both terminals of the voltage source 100 through a first relay 503, and the second voltage source 502 is connected to both terminals of the voltage source 100 through a second relay 504, and a power supply source of the power supply circuit in an initial state is the first voltage source 501; and the control unit 104 is configured to: obtain a real-time voltage of the first voltage source 501, and when determining that a comparison result between the real-time voltage of the first voltage source 501 and a voltage threshold meets a preset condition, switch the power supply source of the power supply circuit from the first voltage source 501 to the second voltage source 502. It should be noted that the voltage threshold is preset in the control unit 104 in advance according to actual needs, and the preset condition may be that the real-time voltage of the first voltage source is continuously less than the voltage threshold during a second time. Whether the first voltage source 501 is connected to the power supply circuit is controlled by turning on or turning off the first relay 503, and whether the second voltage source 502 is connected to the power supply circuit is controlled by turning on or turning off the second relay 504.

Based on the same inventive concept, an embodiment of the present disclosure further provides a control method for a power supply circuit, as described in the following embodiments. Since the principle of solving the problem in the embodiments of the control method for the power supply circuit is similar to those in the above embodiments of the power supply circuit, the implementation of the embodiments of the control method for the power supply circuit may refer to the implementations of the embodiments of the power supply circuit, and the repetitions will not be described again.

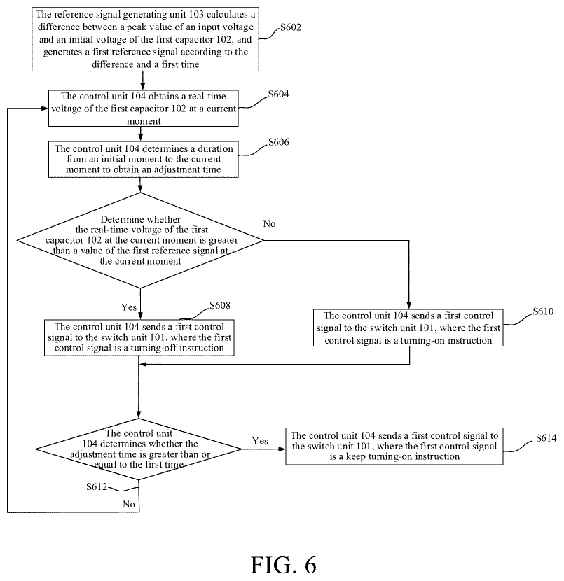

As shown in FIG. 6, an embodiment of the present disclosure provides a control method applied to the power supply circuit shown in FIG. 1, including the following steps.

In step S602, a reference signal generating unit 103 calculates a difference between a peak value of an input voltage and an initial voltage of a first capacitor 102, and generates a first reference signal according to the difference and a first time.

It should be noted that the first reference signal represents a voltage change over time.

Steps S604 to S612 are executed cyclically until the adjustment time is greater than or equal to the first time, and the step S614 is executed, in which the control unit 104 sends the first control signal to the switch unit 101, and the first control signal is a keep turning-on instruction.

In step S604, the control unit 104 obtains the real-time voltage of the first capacitor 102 at a current moment.

It should be noted that the current moment refers to the moment corresponding to each cycle. When the cycle is updated, the current moment changes with the update of the cycle. In a specific implementation, the interval between two cycles may be 10 microseconds, 15 microseconds, 20 microseconds, or the like.

In step S606, the control unit 104 determines a duration from an initial moment to the current moment to obtain the adjustment time.

It should be noted that the initial moment refers to the moment when the control unit 104 starts to generate the first control signal by using the first reference signal and the real-time voltage of the first capacitor 102, i.e., the initial moment when the first cycle starts.

In step S608, if the control unit 104 determines that the real-time voltage of the first capacitor 102 at the current moment is greater than a value of the first reference signal at the current moment, the control unit 104 sends the first control signal to the switch unit 101, where the first control signal is a turning-off instruction.

In step S610, if the control unit 104 determines that the real-time voltage of the first capacitor 102 at the current moment is less than or equal to the value of the first reference signal at the current moment, the control unit 104 sends the first control signal to the switch unit 101, where the first control signal is a turning-on instruction.

In step S612, the control unit 104 determines whether the adjustment time is greater than or equal to the first time, and if it is determined that the adjustment time is less than the first time, the control unit 104 re-obtains the real-time voltage of the first capacitor 102.

It should be noted that the control unit 104 determines whether the adjustment time is greater than or equal to the first time, and if it is determined that the adjustment time is less than the first time, the process returns to step S604 to repeat a new round of the cycle.

It can be seen from the above steps that the control method for the power supply circuit provided in the embodiment of the present disclosure generates the first reference signal according to the difference between the peak value of the input voltage and the initial voltage of the first capacitor 102, and cyclically controls the switch unit 101 to be turned on or turned off, so that the real-time voltage of the first capacitor 102 changes according to the first reference signal during the startup process of the circuit to achieve a fine control of the surge current and realize the purpose of current limiting. Furthermore, due to the characteristics of the switch unit 101, even if a surge current exists, a huge voltage will not be generated across the switch unit 101, thereby avoiding damage to components and improving the safety of the circuit.

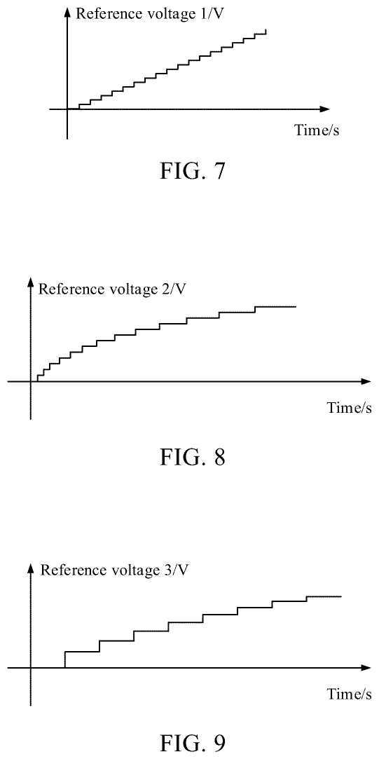

In some embodiments of the present disclosure, the first reference signal includes N steps of reference voltages, each step of the reference voltage corresponds to a segment of reference time, and a sum of N segments of reference time corresponding to the N steps of reference voltages is equal to the first time, where N≥1. It should be noted that the variation of the N steps of reference voltages may be uniform as shown in FIG. 7, i.e., the reference voltage increases by the same amplitude in each step, and the length of the corresponding reference time is the same. The variation may also be non-uniform, as shown in FIG. 8, where the increased amplitude of each step of voltage is the same, but the length of the corresponding reference time is different, and as the reference time increases, the length of the corresponding reference time becomes longer. The variation may also be as shown in FIG. 9, where the length of the reference time corresponding to each step of the voltage is the same, the increased amplitude of each step of the voltage is different, and as the reference time increases, the increased amplitude of each step of the voltage becomes smaller. Those skilled in the art will appreciate that FIGS. 7 to 9 are merely examples of reference signals. As long as the reference voltage is increased in a step-like shape and the slope of the reference signal becomes smaller and smaller, it falls within the protection scope of the present disclosure. As the slope of the reference signal becomes smaller and smaller, the change of the reference voltage given by the reference signal becomes smoother, and the control signal, when controlling the switch unit 101 in accordance with the reference signal, enables the adjustment of the output voltage of the power supply circuit to become smoother and smoother, thereby avoiding as much as possible the surge current brought about by a rapid increase in the output voltage, and avoiding safety hazards.

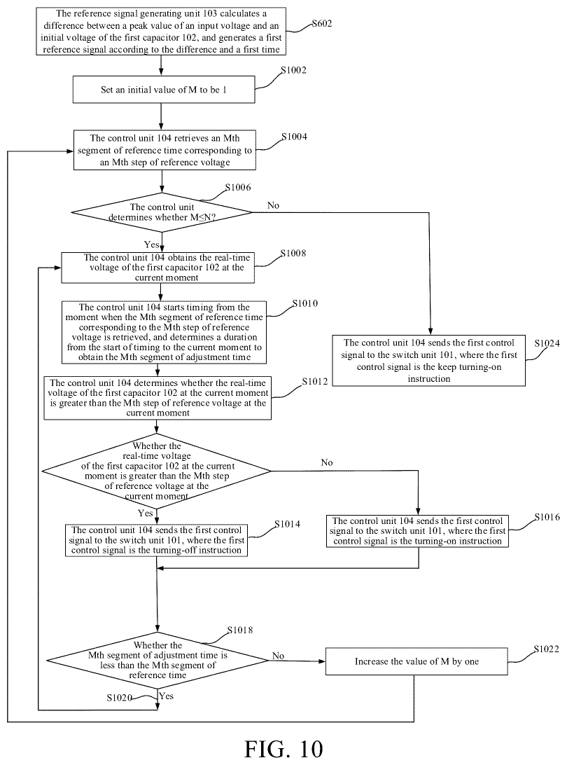

When the first reference signal includes N steps of reference voltages, each step of the reference voltage corresponds to a segment of reference time, and a sum of N segments of reference time corresponding to the N steps of reference voltages is equal to the first time, where N≥1, the control method provided by some embodiments of the present disclosure is shown in FIG. 10, as compared to FIG. 6, after step S602, steps S1002 to S1024 are performed.

In S1002, an initial value of M is set to 1.

It should be noted that M is a parameter representing the number of the steps of the reference voltage retrieved in the subsequent steps, and is an integer starting from 1.

The steps S1004 to S1022 are executed cyclically until the control unit 104 determines that M is greater than N, and the step S1024 is executed, in which the control unit 104 sends the first control signal to the switch unit 101, and the first control signal is the keep turning-on instruction.

In step S1004, the control unit 104 retrieves an Mth segment of reference time corresponding to an Mth step of reference voltage.

In step S1006, when the control unit 104 determines that M is less than or equal to N, the steps S1008 to S1020 are cyclically executed until an Mth segment of adjustment time is greater than or equal to the Mth segment of reference time, and the step S1022 is executed, in which the value of M is increased by one, and the control unit 104 re-retrieves the Mth segment of reference time corresponding to the Mth step of reference voltage. That is, after the value of M is increased by one, steps S1004 to S1020 are repeatedly executed.

In step S1008, the control unit 104 obtains the real-time voltage of the first capacitor 102 at the current moment.

In step S1010, the control unit 104 starts timing from the moment when the Mth segment of reference time corresponding to the Mth step of reference voltage is retrieved, and determines a duration from the start of timing to the current moment to obtain the Mth segment of adjustment time.

In step S1012, the control unit 104 determines whether the real-time voltage of the first capacitor 102 at the current moment is greater than the Mth step of reference voltage at the current moment.

In step S1014, if the control unit 104 determines that the real-time voltage of the first capacitor 102 at the current moment is greater than the Mth step of reference voltage at the current moment, the control unit 104 sends the first control signal to the switch unit 101, where the first control signal is the turning-off instruction.

In step S1016, if the control unit 104 determines that the real-time voltage of the first capacitor 102 at the current moment is less than or equal to the Mth step of reference voltage at the current moment, the control unit 104 sends the first control signal to the switch unit 101, where the first control signal is the turning-on instruction.

In step S1018, the control unit 104 determines whether the Mth segment of adjustment time is less than the Mth segment of reference time.

In step S1020, if the control unit determines that the Mth segment of adjustment time is less than the Mth segment of reference time, the control unit 104 re-obtains the real-time voltage of the first capacitor.

It should be noted that, since the current moment is updated in each cycle, the Mth segment of adjustment time is continuously increasing, and multiple cycles are repeated until the Mth segment of adjustment time reaches the length of time of the Mth segment of reference time, then the switch unit 101 has been controlled in accordance with the reference signal corresponding to the Mth step of reference voltage to finely control the output voltage of the power supply circuit.

In the specific implementation, the control unit 104 first retrieves the Mth segment of reference time corresponding to the Mth step of reference voltage according to the first reference signal, and the control unit 104 determines whether M is less than or equal to N. If M is less than or equal to N, the steps S1008 to S1020 are executed cyclically until the Mth segment of adjustment time is greater than or equal to the Mth segment of reference time. That is, the switch unit 101 is controlled according to the change of the Mth step of reference voltage during the Mth segment of reference time, so that the real-time voltage of the first capacitor 102 changes in accordance with the Mth step of reference voltage. After the change in accordance with the Mth step of reference voltage is over, the value of M is increased by one, a new change in accordance with the Mth step of reference voltage is performed, and the cycle is repeated until M is greater than N and the control ends.

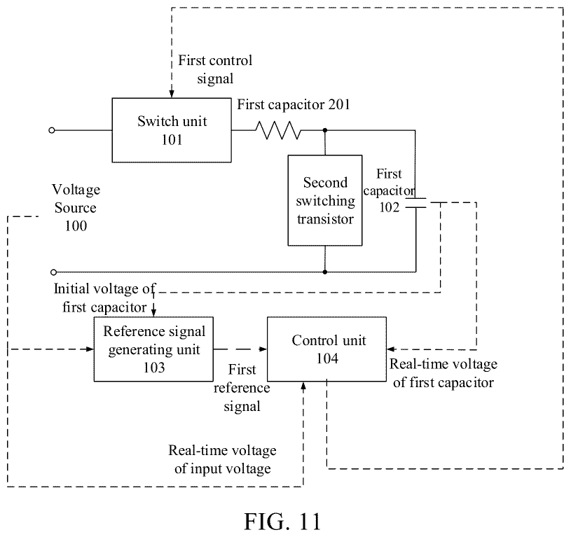

In some embodiments, when the input voltage is AC, there is a situation where the real-time voltage of the input voltage is less than or equal to the real-time voltage of the first capacitor 102. When the real-time voltage of the first capacitor 102 is less than or equal to the Mth step of reference voltage, the input voltage needs to be boosted before supplying power to the first capacitor 102. Therefore, a second switching transistor connected in parallel at both terminals of the first capacitor 102 and an energy storage inductor connected in series between the switch unit 101 and the second switching transistor are provided to form a boost circuit, where the energy storage inductor may be the first inductor 201. As shown in FIG. 11, during the implementation process, step S1016 includes the following steps.

If the control unit 104 determines that the real-time voltage of the first capacitor 102 is less than or equal to the Mth step of reference voltage at the current moment, the control unit 104 sends the first control signal to the switch unit 101, where the first control signal is the turning-on signal, and the control unit 104 obtains the real-time voltage of the input voltage at the current moment.

If the control unit 104 determines that the real-time voltage of the input voltage at the current moment is less than or equal to the real-time voltage of the first capacitor 102 at the current moment, the second switch is controlled to perform an action so that the second switch operates in the boost mode; if the control unit 104 determines that the real-time voltage of the input voltage at the current moment is greater than the real-time voltage of the first capacitor 102 at the current moment, the second switch is kept to be turned off.

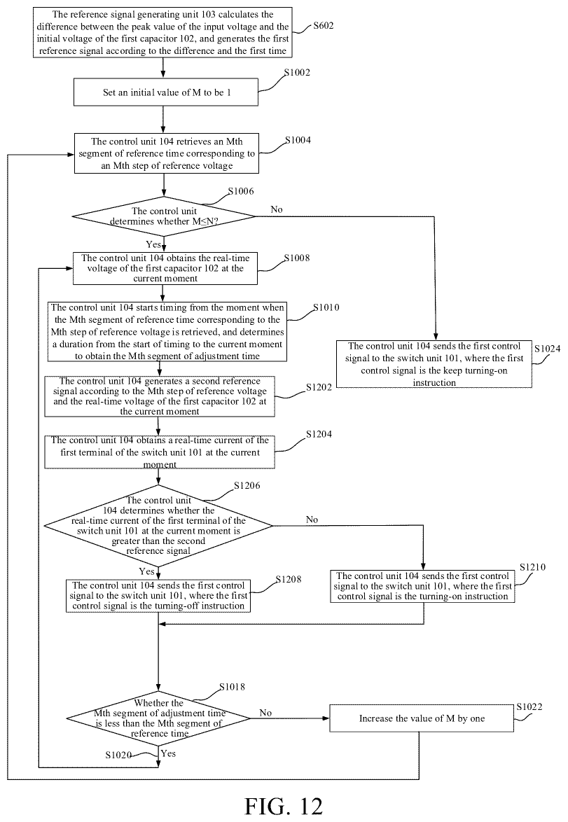

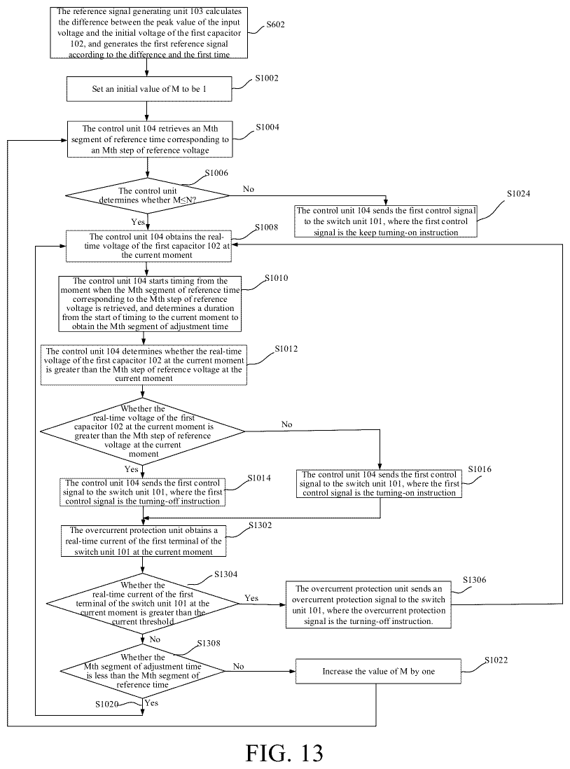

In some embodiments of the present disclosure, the implementation process of step S1012, as shown in FIG. 12, includes the following steps.

In step S1202, the control unit 104 generates a second reference signal according to the Mth step of reference voltage and the real-time voltage of the first capacitor 102 at the current moment.

In step S1204, the control unit 104 obtains a real-time current of the first terminal of the switch unit 101 at the current moment.

In step S1206, the control unit 104 determines whether the real-time current of the first terminal of the switch unit 101 at the current moment is greater than the second reference signal.

Accordingly, in FIG. 12, the step S1014 is changed to the step S1208. If the control unit 104 determines that the real-time current of the first terminal of the switch unit 101 at the current moment is greater than the second reference signal, the control unit 104 sends the first control signal to the switch unit 101, where the first control signal is the turning-off instruction.

The step S1016 is changed to the step S1210. If the control unit 104 determines that the real-time current of the first terminal of the switch unit 101 at the current moment is less than or equal to the second reference signal, the control unit 104 sends the first control signal to the switch unit 101, where the first control signal is the turning-on instruction.

It should be noted that the second reference signal represents the change of the current in the circuit over time, i.e., a target change of the current at the first terminal of the switch unit 101 when a preset reference voltage is determined as the adjustment target based on the Mth step of reference voltage and the real-time voltage of the first capacitor 102 at the current moment. The switch unit 101 is controlled to be turned on or off according to the comparison result between the second reference signal and the real-time current of the first terminal of the switch unit 101, so that the real-time current of the first terminal of the switch unit 101 is adjusted with the second reference signal as the target.

In some embodiments of the present disclosure, the power supply circuit further includes an overcurrent protection unit, and the overcurrent protection unit is provided with a current threshold. Accordingly, the control method provided, as shown in FIG. 13, further includes the following steps before the step S1018 compared with FIG. 10.

In step S1302, the overcurrent protection unit obtains a real-time current of the first terminal of the switch unit 101 at the current moment.

In step S1304, the overcurrent protection unit determines whether the real-time current of the first terminal of the switch unit 101 at the current moment is greater than the current threshold.

In step S1306, the overcurrent protection unit sends an overcurrent protection signal to the switch unit 101 if the real-time current of the first terminal of the switch unit 101 at the current moment is greater than the current threshold, where the overcurrent protection signal is a turning-off instruction, and the control unit 104 re-obtains the real-time voltage of the first capacitor 102 until the overcurrent protection unit determines that the real-time current of the first terminal of the switch unit 101 at the current moment is less than or equal to the current threshold.

Accordingly, the step S1018 is changed to the step S1308 and includes:
if the real-time current of the first terminal of the switch unit 101 at the current moment is less than or equal to the current threshold, the control unit 104 determining whether the Mth segment of adjustment time is less than the Mth segment of reference time.

It should be noted that the priority of the overcurrent protection signal is higher than that of the first control signal, that is, when the instruction of the overcurrent protection signal conflicts with the instruction of the first control signal, the instruction of the overcurrent protection signal is executed until the overcurrent protection unit determines that the real-time current of the first terminal of the switch unit 101 at the current moment is less than or equal to the current threshold.

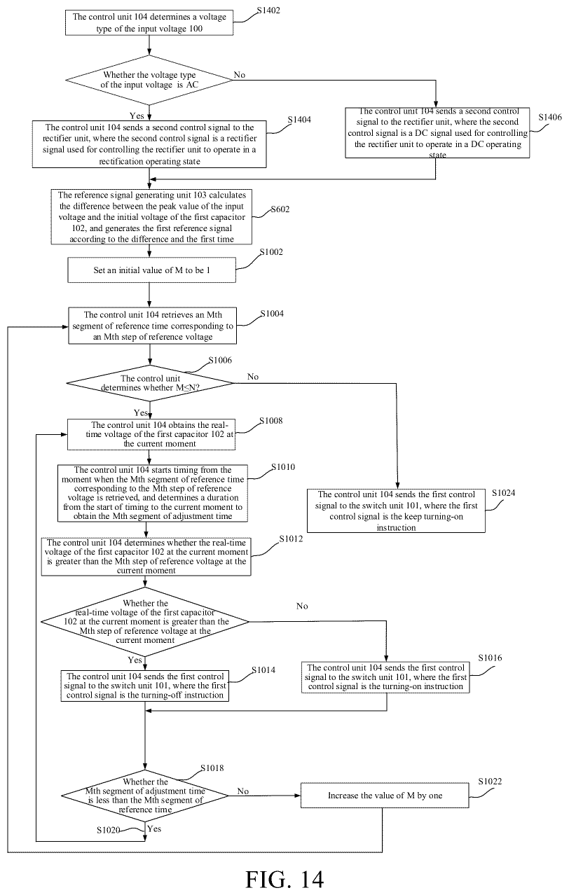

In some embodiments of the present disclosure, the power supply circuit further includes a rectifier unit, the rectifier unit includes a first terminal and a second terminal, the first terminal of the rectifier unit is electrically coupled to the voltage source 100, and the second terminal of the rectifier unit is electrically coupled to the switch unit 101. Accordingly, on the basis of FIG. 10, the provided control method, as shown in FIG. 14, further includes the following steps before the reference signal generating unit 103 calculates the difference between the peak value of the input voltage and the initial voltage of the first capacitor 102, and generates the first reference signal according to the difference and the first time.

In step S1402, the control unit 104 determines a voltage type of the input voltage.

In step S1404, the control unit 104 sends a second control signal to the rectifier unit when the control unit 104 determines that the voltage type of the input voltage is AC, where the second control signal is a rectifier signal used for controlling the rectifier unit to operate in a rectification operating state.

In step S1406, the control unit 104 sends a second control signal to the rectifier unit when the control unit 104 determines that the voltage type of the input voltage is DC, where the second control signal is a DC signal used for controlling the rectifier unit to operate in a DC operating state.

In some embodiments of the present disclosure, the switch unit 101 includes a switching transistor and a relay connected in parallel, where the turning-on instruction is used to control the switching transistor to be turned on; the turning-off instruction is used to control the switching transistor to be turned off; the keep turning-on instruction is used to control the switching transistor to be turned off, and to control the relay to be turned on.

In some embodiments of the present disclosure, the power supply circuit is further provided with an overcurrent protection unit, a first inductor and a freewheeling unit, where a first terminal of the first inductor and a first terminal of the freewheeling unit are both electrically coupled to the second terminal of the switch unit 101, a second terminal of the first inductor is electrically coupled to the first terminal of the first capacitor 102, a second terminal of the freewheeling unit is electrically coupled to the second terminal of the first capacitor 102, and the overcurrent protection unit is provided with a current threshold.

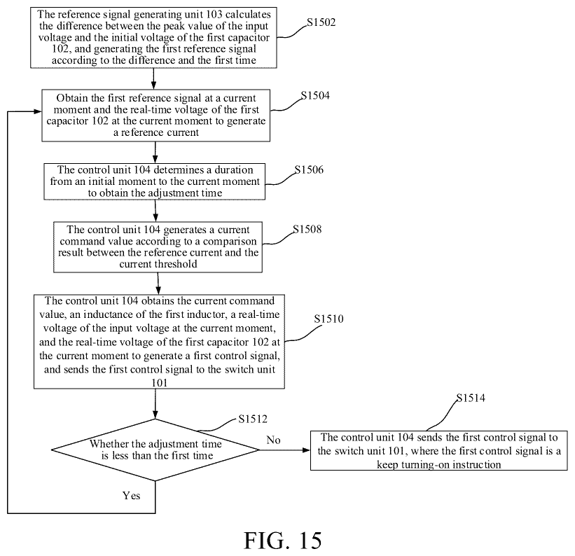

Accordingly, as shown in FIG. 15, the control method applied to the power supply circuit includes the following steps.

In step S1502, the reference signal generating unit 103 calculates the difference between the peak value of the input voltage and the initial voltage of the first capacitor 102, and generates the first reference signal according to the difference and the first time; where the reference signal represents a voltage change over time.

Steps S1504 to S1512 are cyclically performed until an adjustment time is greater than or equal to the first time, then the step S1514 is executed, in which the control unit 104 sends the first control signal to the switch unit 101, where the first control signal is a keep turning-on instruction.

In step S1504, the control unit 104 obtains the first reference signal at a current moment and the real-time voltage of the first capacitor 102 at the current moment to generate a reference current.

In step S1506, the control unit 104 determines a duration from an initial moment to the current moment to obtain the adjustment time.

In step S1508, the control unit 104 generates a current command value according to a comparison result between the reference current and the current threshold.

It should be noted that when the reference current is greater than the current threshold, the current command value is the current threshold; when the reference current is less than or equal to the current threshold, the current command value is the reference current.

In step S1510, the control unit 104 obtains the current command value, an inductance of the first inductor, a real-time voltage of the input voltage at the current moment, and the real-time voltage of the first capacitor 102 at the current moment to generate a first control signal, and sends the first control signal to the switch unit 101; where the first control signal is used to control the switch unit 101 to be turned on or off.

It should be noted that the first control signal may be a PWM control signal, including an on portion and an off portion, where an on-time and an off-time are included in one control cycle. Specifically, the on-time tₒₙ and the off-time t_{off} are calculated according to the following equations:

$${t}_{on} = ( 2 \times L \times I\_ref ) / V\_in \_peak$$

$${t}_{off} = {t}_{on} \times ( Vin / ( Vo - Vin ) )$$

where tₒₙ represents the on time in one control cycle, s;
t_{off} represents the off time in one control cycle, s;
L represents the inductance of the first inductor, H;
I_ref represents the current command value, A;
V_in_peak represents the peak value of the input voltage, V;
Vin represents the real-time voltage of the input voltage at the current moment, V;
Vo represents the real-time voltage of the first capacitor 102 at the current moment, V.

In step S1512, the control unit 104 determines whether the adjustment time is less than the first time, and if the control unit 104 determines that the adjustment time is less than the first time, the control unit 104 re-generates a reference current.

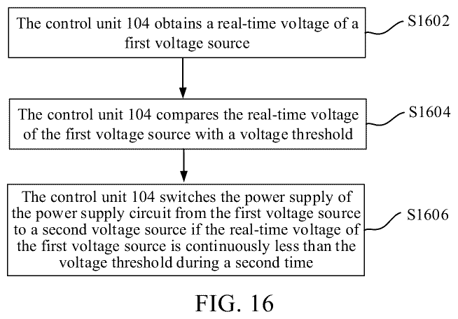

In some embodiments of the present disclosure, the voltage source in the power supply circuit includes a first voltage source and a second voltage source, and a power supply source of the power supply circuit in an initial state is the first voltage source. Accordingly, the control method for the power supply circuit provided is shown in FIG. 16 and includes the following steps.

In step S1602, the control unit 104 obtains a real-time voltage of the first voltage source.

In step S1604, the control unit 104 compares the real-time voltage of the first voltage source with a voltage threshold.

In step S1606, the control unit 104 switches the power supply source of the power supply circuit from the first voltage source to the second voltage source if the real-time voltage of the first voltage source is continuously less than the voltage threshold during a second time.

It should be noted that after the implementation of the step S1606, the power supply circuit may generate a surge current due to the switching of the power supply source. Therefore, in the specific implementation, after the step S1606 is implemented, it is necessary to enter the anti-surge startup phase, that is, it is necessary to execute the control method for the power supply circuit provided in the above embodiments such as in FIG. 6, 10, 12, 13, 14 or 15 to control the surge current and prevent damage to the circuit, which will not be repeated herein.

Specifically, the switch unit 101 includes a switching transistor and a relay connected in parallel. Accordingly, the specific implementation process of the step S1606 includes: controlling, by the control unit 104, the relay to be turned off and the switching transistor to be turned on; controlling, by the control unit 104, the power supply of the first voltage source to be disconnected and the switching transistor to be turned off; and controlling, by the control unit, the second voltage source to be accessed, so that the second voltage source supplies power to the power supply circuit.

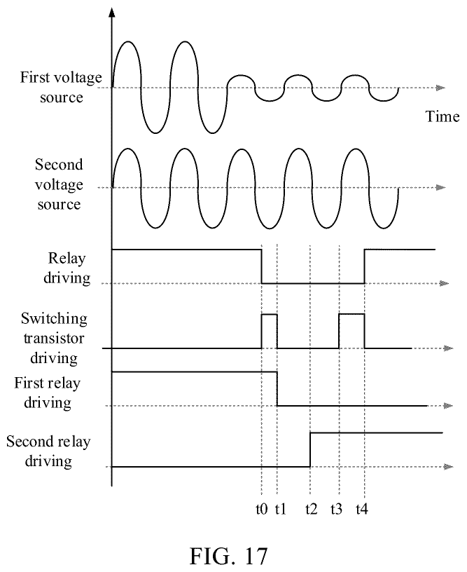

During specific implementation, the first voltage source is connected to the first relay to supply energy to the power supply circuit, and the second voltage source is connected to the second relay to supply energy to the power supply circuit. As shown in FIG. 17, the changing process of driving signals of the relay, the switching transistor, the first relay and the second relay during the process of switching the first voltage source to the second voltage source is illustrated. At moment to, the control unit 104 determines that the real-time voltage of the first voltage source has been less than a preset voltage threshold for a period of time, and the period of time is greater than or equal to the second time. At this time, the control unit 104 controls the relay to be turned off and controls the switching transistor to be turned on, thereby replacing the relay with the switching transistor to realize the turning-on or turning-off of the switch. The switching transistor is turned on for a period of time. At moment t1, the control unit 104 controls the switching transistor to be turned off, and controls the first relay to be turned off so that the first voltage source no longer supplies power. At moment t2, the control unit 104 controls the second relay to be turned on to access the second voltage source, so that the second voltage source supplies power to the power supply circuit. And during the period from moment t1 to moment t3, the switching transistor remains to be turned off to ensure that other components in the power supply circuit are disconnected from the power supply source when the power supply source is switched, that is, a power-off switching is performed to avoid safety hazards brought about by charged switching. At moment t3, the power supply source has been switched, and the control unit 104 controls the switching transistor to be turned on for a period of time until the moment t4, and the anti-surge startup phase ends. At this time, the control unit 104 controls the switching transistor to be turned off again, and the control unit 104 controls the relay to be turned on, so that the operating current flows through the relay in a stable operating state to reduce the power loss in the circuit.

In order to more clearly explain the power supply circuit and the control method for the power supply circuit provided by the embodiments of the present disclosure, a specific example is now provided for further explanation.

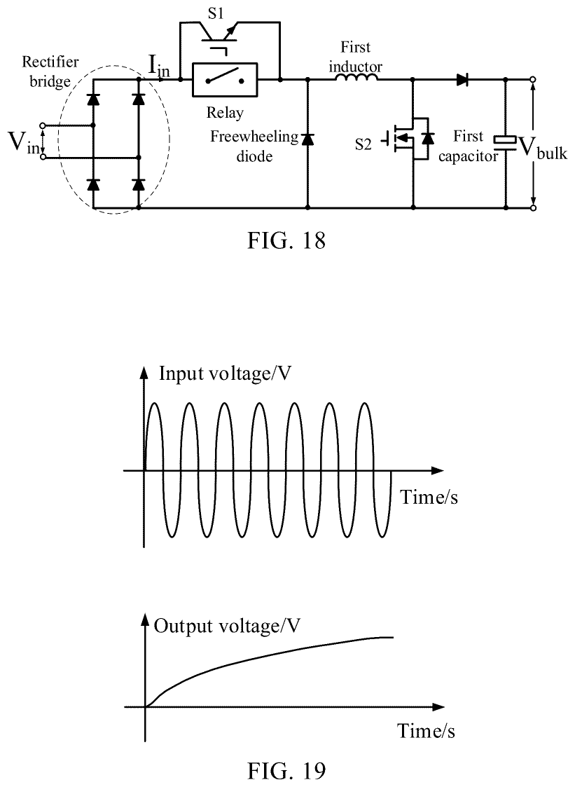

The power supply circuit of the present specific example is shown in FIG. 18. In the present specific example, the switch unit includes a first switching transistor S1 and a relay connected in parallel. The input voltage Vin enters the switch unit through the rectifier bridge, the current at the first terminal of the first switching transistor S1 is noted as Iin, the second terminal of the first switching transistor S1 is connected to the first terminal of the first inductor and the cathode of the freewheeling diode, respectively, and the anode of the freewheeling diode is connected to the second terminal of the first capacitor. The second terminal of the first inductor is connected to the first terminal of the second switching transistor S2 and an anode of a diode, and the second terminal of the second switching transistor S2 is connected to the second terminal of the first capacitor. The cathode of the diode is connected to the first terminal of the first capacitor. The voltage of the first capacitor is denoted as Vbulk. The power supply circuit is subsequently connected to a post stage circuit (not shown in the figure), which is connected in parallel to two terminals of the first capacitor. The control unit and the reference signal generating unit are integrated in a control module.

The control module determines whether the input voltage is in a DC or AC form by voltage sampling the input voltage, and determines the peak value of the input voltage as a basis for generating the first reference signal. After determining that the input voltage is in DC form, the control module determines that the circuit operates in a Buck mode, generates a control signal for the second switching transistor S2, controls the second switching transistor S2 to remain to be turned off, and generates the first reference signal to control the first switching transistor S1. After determining that the input voltage is in AC form, the control module determines the operating mode according to the real-time value of the input voltage and the real-time value of the first capacitor: when the real-time value of the input voltage is higher than the real-time value of the first capacitor, the control module determines that the circuit operates in the Buck mode, generates a control signal for the second switching transistor S2, controls the second switching transistor S2 to remain to be turned off, and generates the first reference signal to control the first switching transistor S1. When the real-time value of the input voltage is less than or equal to the real-time value of the first capacitor, it is determined that the circuit operates in a Boost mode, the first control signal is generated to control the first switching transistor S1 to remain in the turned-on state, and the control signal is generated for the second switching transistor S2 to control the second switching transistor S2 to be turned on or off. During this process, Iin is sampled in real time. Through the sampling, once it is found that the value of Iin exceeds the set current threshold, the control module generates an overcurrent protection signal to control the first switching transistor S1 and/or the second switching transistor S2 to prevent the current from continuing to increase and perform overcurrent protection.

When generating the first control signal, the reference voltage in the first reference signal and the real-time voltage of the first capacitor may be used as inputs of a voltage loop, and the voltage loop outputs the first control signal. A control loop with a voltage outer loop and a current inner loop may also be used, in which the reference voltage in the first reference signal and the real-time voltage of the first capacitor are used as inputs to the voltage loop, and the current command value and the current at the first terminal of the first switching transistor S1 are used as inputs to the current loop, and the control loop outputs the first control signal, which results in a smoother control process through the dual control of the voltage and the current.

FIG. 19 shows a waveform of the AC input voltage of the power supply circuit in the present specific embodiment, and a waveform of the voltage Vbulk of the first capacitor obtained by the above process using the first reference signal as shown in FIG. 8. It can be seen that the voltage Vbulk of the first capacitor increases steadily with the increase of the startup time, and increases to the peak value of the input voltage after the first time has elapsed. The controllability of the output voltage is achieved, which is beneficial to the stability and safety of the subsequent circuit. During the control process, the current in the circuit is limited to avoid overcurrent losses and greatly improve the safety of the circuit.

An embodiment of the present disclosure further provides an electronic device, where the electronic device includes: a processor; and a memory configured to store executable instructions of the processor; where the processor is configured to execute any of the control method for the power supply circuit as described in the above embodiments by executing the executable instructions.

An embodiment of the present disclosure further provides a computer-readable storage medium, on which a computer program is stored. When the computer program is executed by a processor, any of the control method for the power supply circuit as described in the above embodiments is implemented.

An embodiment of the present disclosure further provides a computer program product, where the computer program product includes a computer program, when the computer program is executed by a processor, any of the control method for the power supply circuit as described in the above embodiments is implemented.

It will be appreciated by those skilled in the art that various aspects of the present disclosure may be implemented as systems, methods or program products. Therefore, various aspects of the present disclosure may be specifically implemented in the following forms, i.e., a complete hardware implementation, a complete software implementation (including firmware, microcode, etc.), or an implementation combining hardware and software aspects, which may be collectively referred to herein as a “circuit”, “module” or “system”. It should be noted that although several modules or units of a device for action execution are mentioned in the above detailed description, such division is not mandatory. In fact, according to the implementations of the present disclosure, the features and functions of two or more modules or units described above may be embodied in one module or unit. Conversely, the features and functions of one module or unit described above may be further divided to be embodied by multiple modules or units.

Furthermore, although various steps of the methods of the present disclosure are depicted in the drawings in a specific order, it does not require or imply that the steps must be performed in that specific order, or that all of the illustrated steps must be performed to achieve the desired results. Additionally or alternatively, certain steps may be omitted, multiple steps may be combined into one step for execution, and/or one step may be decomposed into multiple steps for execution, etc.

Through the description of the above implementations, those skilled in the art may easily understand that the exemplary implementations described here may be implemented by software or by software combined with necessary hardware(s). Therefore, the technical solutions according to the implementations of the present disclosure may be embodied in the form of a software product that may be stored in a non-volatile storage medium (which may be a CD-ROM, a USB flash drive, a mobile hard disk, etc.) or on a network, and the software product includes several instructions to cause a computing device (which may be a personal computer, a server, a mobile terminal, a network device, etc.) to execute the method according to the implementations of the present disclosure.

Other implementation solutions of the present disclosure will be readily apparent to those skilled in the art upon consideration of the specification and practice of the present disclosure disclosed herein. The present disclosure is intended to cover any variations, uses, or adaptations of the present disclosure that follow the general principles of the present disclosure and include common knowledge or customary technical means in the technical field that are not disclosed in the present disclosure. The specification and embodiments are to be considered as exemplary only, and the true scope and spirit of the present disclosure are indicated by the appended claims.

What is claimed is:

1. A power supply circuit, comprising:
a voltage source, providing an input voltage and comprising a first terminal and a second terminal;
a switch unit, comprising a first terminal and a second terminal, wherein the first terminal of the switch unit is electrically coupled to the first terminal of the voltage source;
a first capacitor, having an initial voltage, wherein the first capacitor comprises a first terminal and a second terminal, the first terminal of the first capacitor is electrically coupled to the second terminal of the switch unit, and the second terminal of the first capacitor is electrically coupled to the second terminal of the voltage source;
a reference signal generating unit, configured to generate a first reference signal according to a first time, and a difference between a peak value of the input voltage and the initial voltage of the first capacitor; and
a control unit, configured to obtain a real-time voltage of the first capacitor, and generate a first control signal according to the first reference signal and the real-time voltage of the first capacitor, wherein the first control signal is used to control the switch unit.

2. The power supply circuit according to claim 1, wherein the first reference signal comprises N steps of reference voltages, each step of the reference voltage corresponds to a segment of reference time, and a sum of N segments of reference time corresponding to the N steps of reference voltages is equal to the first time, wherein N≥1.

3. The power supply circuit according to claim 2, wherein the control unit generates the first control signal according to the first reference signal, the real-time voltage of the first capacitor, and a real-time current of the first terminal of the switch unit.

4. The power supply circuit according to claim 2, further comprising:
a first inductor and a freewheeling unit, wherein a first terminal of the first inductor and a first terminal of the freewheeling unit are both electrically coupled to the second terminal of the switch unit, a second terminal of the first inductor is electrically coupled to the first terminal of the first capacitor, and a second terminal of the freewheeling unit is electrically coupled to the second terminal of the first capacitor.

5. The power supply circuit according to claim 4, further comprising: a voltage conversion unit, wherein the voltage conversion unit comprises the first inductor.

6. The power supply circuit according to claim 5, wherein the voltage conversion unit comprises a power factor correction circuit or a boost circuit.

7. The power supply circuit according to claim 2, further comprising:
an overcurrent protection unit, wherein the overcurrent protection unit generates an overcurrent protection signal according to a current threshold and a real-time current of the first terminal of the switch unit to perform overcurrent protection for the power supply circuit.

8. The power supply circuit according to claim 2, further comprising:
a rectifier unit, comprising a first terminal and a second terminal, wherein the first terminal of the rectifier unit is electrically coupled to the voltage source, and the second terminal of the rectifier unit is electrically coupled to the switch unit.

9. The power supply circuit according to claim 2, wherein the switch unit comprises a switching transistor and a relay connected in parallel.

10. The power supply circuit according to claim 1, wherein the voltage source comprises: a first voltage source and a second voltage source;
wherein a power supply source of the power supply circuit in an initial state is the first voltage source; and
the control unit is configured to: obtain a real-time voltage of the first voltage source, and switch the power supply source of the power supply circuit from the first voltage source to the second voltage source in response to determining that a comparison result between the real-time voltage of the first voltage source and a voltage threshold meets a preset condition.

11. A control method applied to the power supply circuit according to claim 1, comprising:
the reference signal generating unit calculating the difference between the peak value of the input voltage and the initial voltage of the first capacitor, and generating the first reference signal according to the difference and the first time; wherein the first reference signal represents a voltage change over time;
cyclically performing following steps until an adjustment time is greater than or equal to the first time, and sending, by the control unit, the first control signal to the switch unit, wherein the first control signal is a keep turning-on instruction:
obtaining, by the control unit, a real-time voltage of the first capacitor at a current moment;
determining, by the control unit, a duration from an initial moment to the current moment to obtain the adjustment time;
sending, by the control unit, the first control signal to the switch unit in response to that the control unit determines that the real-time voltage of the first capacitor at the current moment is greater than a value of the first reference signal at the current moment, wherein the first control signal is a turning-off instruction;
sending, by the control unit, the first control signal to the switch unit in response to that the control unit determines that the real-time voltage of the first capacitor at the current moment is less than or equal to the value of the first reference signal at the current moment, wherein the first control signal is a turning-on instruction; and
determining, by the control unit, whether the adjustment time is greater than or equal to the first time, and re-obtaining, by the control unit, the real-time voltage of the first capacitor in response to determining that the adjustment time is less than the first time.

12. The control method according to claim 11, wherein the first reference signal comprises N steps of reference voltages, each step of the reference voltage corresponds to a segment of reference time, and a sum of N segments of reference time corresponding to the N steps of reference voltages is equal to the first time, wherein N≥1;
wherein after generating the first reference signal according to the difference and the first time, the method further comprises:
setting an initial value of M to 1;
cyclically performing following steps until the control unit determines that M is greater than N, and sending, by the control unit, the first control signal to the switch unit, wherein the first control signal is the keep turning-on instruction:
retrieving, by the control unit, an Mth segment of reference time corresponding to an Mth step of reference voltage;
in response to that the control unit determines that M is less than or equal to N, cyclically performing following steps until an Mth segment of adjustment time is greater than or equal to the Mth segment of reference time, increasing the value of M by one, and re-retrieving, by the control unit, the Mth segment of reference time corresponding to the Mth step of reference voltage:
obtaining, by the control unit, the real-time voltage of the first capacitor at the current moment;
the control unit starting timing from a moment when the Mth segment of reference time corresponding to the Mth step of reference voltage is retrieved, and determining a duration from start of timing to the current moment to obtain the Mth segment of adjustment time;
determining, by the control unit, whether the real-time voltage of the first capacitor at the current moment is greater than the Mth step of reference voltage at the current moment;
sending, by the control unit, the first control signal to the switch unit in response to that the control unit determines that the real-time voltage of the first capacitor at the current moment is greater than the Mth step of reference voltage at the current moment, wherein the first control signal is the turning-off instruction;
sending, by the control unit, the first control signal to the switch unit in response to that the control unit determines that the real-time voltage of the first capacitor at the current moment is less than or equal to the Mth step of reference voltage at the current moment, wherein the first control signal is the turning-on instruction;
determining, by the control unit, whether the Mth segment of adjustment time is less than the Mth segment of reference time;
re-obtaining, by the control unit, the real-time voltage of the first capacitor in response to that the control unit determines that the Mth segment of adjustment time is less than the Mth segment of reference time.

13. The control method according to claim 12, wherein determining, by the control unit, whether the real-time voltage of the first capacitor at the current moment is greater than the Mth step of reference voltage at the current moment, comprises:
generating, by the control unit, a second reference signal according to the Mth step of reference voltage and the real-time voltage of the first capacitor at the current moment;
obtaining, by the control unit, a real-time current of the first terminal of the switch unit at the current moment;
determining, by the control unit, whether the real-time current of the first terminal of the switch unit at the current moment is greater than the second reference signal;
wherein sending, by the control unit, the first control signal to the switch unit in response to that the control unit determines that the real-time voltage of the first capacitor at the current moment is greater than the Mth step of reference voltage at the current moment, the first control signal being the turning-off instruction, comprises:
sending, by the control unit, the first control signal to the switch unit in response to that the control unit determines that the real-time current of the first terminal of the switch unit at the current moment is greater than the second reference signal, wherein the first control signal is the turning-off instruction;
wherein sending, by the control unit, the first control signal to the switch unit in response to that the control unit determines that the real-time voltage of the first capacitor at the current moment is less than or equal to the Mth step of reference voltage at the current moment, the first control signal being the turning-on instruction, comprises:
sending, by the control unit, the first control signal to the switch unit in response to that the control unit determines that the real-time current of the first terminal of the switch unit at the current moment is less than or equal to the second reference signal, wherein the first control signal is the turning-on instruction.

14. The control method according to claim 12, wherein the power supply circuit further comprises an overcurrent protection unit, and the overcurrent protection unit is provided with a current threshold;
wherein before determining, by the control unit, whether the Mth segment of adjustment time is less than the Mth segment of reference time, the method further comprises:
obtaining, by the overcurrent protection unit, a real-time current of the first terminal of the switch unit at the current moment;
determining, by the overcurrent protection unit, whether the real-time current of the first terminal of the switch unit at the current moment is greater than the current threshold;
sending, by the overcurrent protection unit, an overcurrent protection signal to the switch unit in response to that the real-time current of the first terminal of the switch unit at the current moment is greater than the current threshold, the overcurrent protection signal being the turning-off instruction, and re-obtaining, by the control unit, the real-time voltage of the first capacitor until the overcurrent protection unit determines that the real-time current of the first terminal of the switch unit at the current moment is less than or equal to the current threshold;
wherein determining, by the control unit, whether the Mth segment of adjustment time is less than the Mth segment of reference time, comprises:
determining, by the control unit, whether the Mth segment of adjustment time is less than the Mth segment of reference time in response to that the real-time current of the first terminal of the switch unit at the current moment is less than or equal to the current threshold.

15. The control method according to claim 12, wherein the power supply circuit further comprises a rectifier unit, the rectifier unit comprises a first terminal and a second terminal, the first terminal of the rectifier unit is electrically coupled to the voltage source, and the second terminal of the rectifier unit is electrically coupled to the switch unit;
wherein before the reference signal generating unit calculating the difference between the peak value of the input voltage and the initial voltage of the first capacitor, and generating the first reference signal according to the difference and the first time, the control method further comprises:
determining, by the control unit, a voltage type of the input voltage;
sending, by the control unit, a second control signal to the rectifier unit in response to that the control unit determines that the voltage type of the input voltage is AC, wherein the second control signal is a rectifier signal used for controlling the rectifier unit to operate in a rectification operating state; and
sending, by the control unit, the second control signal to the rectifier unit in response to that the control unit determines that the voltage type of the input voltage is DC, wherein the second control signal is a DC signal used for controlling the rectifier unit to operate in a DC operating state.

16. The control method according to claim 12, wherein the switch unit comprises a switching transistor and a relay connected in parallel;
the turning-on instruction is used to control the switching transistor to be turned on;
the turning-off instruction is used to control the switching transistor to be turned off; and
the keep turning-on instruction is used to control the switching transistor to be turned off, and to control the relay to be turned on.

17. A control method applied to the power supply circuit according to claim 1, wherein the power supply circuit is further provided with an overcurrent protection unit, a first inductor and a freewheeling unit, wherein a first terminal of the first inductor and a first terminal of the freewheeling unit are both electrically coupled to the second terminal of the switch unit, a second terminal of the first inductor is electrically coupled to the first terminal of the first capacitor, a second terminal of the freewheeling unit is electrically coupled to the second terminal of the first capacitor, and the overcurrent protection unit is provided with a current threshold;
wherein the control method comprises:
the reference signal generating unit calculating the difference between the peak value of the input voltage and the initial voltage of the first capacitor, and generating the first reference signal according to the difference and the first time; wherein the first reference signal represents a voltage change over time;
cyclically performing following steps until an adjustment time is greater than or equal to the first time, and sending, by the control unit, the first control signal to the switch unit, wherein the first control signal is a keep turning-on instruction:
obtaining, by the control unit, the first reference signal at a current moment and the real-time voltage of the first capacitor at the current moment to generate a reference current;
determining, by the control unit, a duration from an initial moment to the current moment to obtain the adjustment time;
generating, by the control unit, a current command value according to a comparison result between the reference current and the current threshold;
the control unit obtaining the current command value, an inductance of the first inductor, a real-time voltage of the voltage source at the current moment, and the real-time voltage of the first capacitor at the current moment to generate the first control signal, and sending the first control signal to the switch unit; wherein the first control signal is used to control the switch unit to be turned on or off; and
determining, by the control unit, whether the adjustment time is less than the first time, and re-generating, by the control unit, the reference current in response to that the control unit determines that the adjustment time is less than the first time.

18. A control method applied to a power supply circuit according to claim 1, wherein the voltage source comprises a first voltage source and a second voltage source, and a power supply source of the power supply circuit in an initial state is the first voltage source;
wherein the control method comprises:
obtaining, by the control unit, a real-time voltage of the first voltage source;
comparing, by the control unit, the real-time voltage of the first voltage source with a voltage threshold;
switching, by the control unit, the power supply source of the power supply circuit from the first voltage source to the second voltage source in response to that the real-time voltage of the first voltage source is continuously less than the voltage threshold during a second time.

19. The control method according to claim 18, wherein the switch unit comprises a switching transistor and a relay connected in parallel;
wherein switching, by the control unit, the power supply source of the power supply circuit from the first voltage source to the second voltage source, comprises:
controlling, by the control unit, the relay to be turned off and the switching transistor to be turned on;
controlling, by the control unit, a power supply of the first voltage source to be disconnected and the switching transistor to be turned off, and
controlling, by the control unit, the second voltage source to be accessed, so that the second voltage source supplies power to the power supply circuit.
